(19) United States
(12) Patent Application Publication
(10) Pub. No.: US 2025/0350414 A1
(43) Pub. Date: Nov. 13, 2025

(54) HYBRID PER-FREQUENCY RANGE AND PER-USER EQUIPMENT MEASUREMENT GAP CAPABILITIES

(71) Applicant: APPLE INC., Cupertino, CA (US)

(72) Inventors: Yang Tang, San Jose, CA (US); Dawei Zhang, Saratoga, CA (US); Xiang Chen, Campbell, CA (US); Manasa Raghavan, Sunnyvale, CA (US); Jie Cui, San Jose, CA (US); Qiming Li, Beijing (CN)

(21) Appl. No.: 18/860,102

(22) PCT Filed: May 30, 2022
(86) PCT No.: PCT/CN2022/095974

§ 371 Date: Oct. 25, 2024

(51) Int. Cl. H04L 5/00

(52) U.S. Cl. CPC H04L 5/001; H04L 5/0098

(57) ABSTRACT

Systems and methods for indications and determinations related to the use of per-frequency range (FR) measurement gap procedures or per-user equipment (UE) measurement gap procedures are disclosed herein. A UE may inform a base station when it is infeasible for the UE to perform per-FR measurement gap procedures with a particular band combination configured to the UE. A CE may alternatively or additionally determine and indicate, to the base station: one or more CC limits, a maximum number of aggregated bands across all FRs, a maximum number of aggregated bands in a particular FR, and/or a maximum number of FRs for which a per-FR measurement gap procedure is supported at the UE. A base station may use one or more of these values to determine whether the UE will use per-FR or per-UE measurement gap procedures with a configured band combination (and/or with a corresponding fallback band combination).

### TECHNICAL FIELD

This application relates generally to wireless communication systems, including wireless communication systems that are capable of implementing per-frequency range (FR) measurement gaps.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges (FRs). For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mm Wave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a method of a UE, according to an embodiment.

FIG. 2 illustrates a method of a UE, according to an embodiment.

FIG. 3 illustrates a method of a UE, according to an embodiment.

FIG. 4 illustrates a method of a UE, according to an embodiment.

FIG. 5 illustrates a method of a base station, according to an embodiment.

FIG. 6 illustrates a method of a UE, according to an embodiment.

FIG. 7 illustrates a method of a base station, according to an embodiment.

FIG. 8 illustrates an example architecture of a wireless communication system, according to embodiments disclosed herein.

FIG. 9 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

One or more measurement gaps may be provided at a UE. A measurement gap may be a period of time where uplink (UL) and downlink (DL) transmissions between the UE and the network relative to a radio frequency integrated circuit (RFIC) of the UE are paused (e.g., not scheduled), such that radio frequency (RF) resources of the UE corresponding to that RFIC are free to instead perform a measurement (e.g., on an otherwise not-used frequency, for example to monitor for potential handover conditions).

In some wireless communication networks, two types of measurement gap configurations may be defined. A first measurement gap configuration may be a “per-UE” measurement gap configuration. In UE using a per-UE measurement gap procedure corresponding to a per-UE measurement gap configuration, it may be that a single RFIC of the UE covers both FR1 and FR2 for the UE. In such circumstances, the use of this RFIC for UL/DL signaling is paused attendant to providing the measurement gap. Accordingly, a measurement gap that is configured for a measurement object (MO) measurement in one of FR1 and FR2 will impact the UE's ability to simultaneously communicate on either/each of FR1 and FR2 via the (one) RFIC. Accordingly, during such a measurement gap, there may be no uplink (UL) and no downlink (DL) operation on either of FR1 or FR2 (e.g., on the entire set of FRs used by the UE).

A second measurement gap configuration may be a “per-FR” measurement gap configuration. In UE using a per-FR measurement gap procedure corresponding to a per-FR measurement gap configuration, it may be that there are multiple (e.g., in some cases two) discrete RFICs, each dedicated to covering one of FR1 and FR2, respectively, for the UE. In such circumstances, a measurement gap that is configured for an MO measurement in one of FR1 and FR2 may provide a sufficient measurement gap by pausing UL/DL transmission on only the RFIC corresponding to the FR in which the MO is found. Meanwhile, the UE continues to be able to communicate on the other of FR1 and FR2 (via the other RFIC). In other words, when using a per-FR measurement gap procedure, a measurement gap may only affect the FR for which the MO is being measured (rather than all FRs used at the UE). The use of a per-FR measurement gap configuration may be advantageous over the per-UE measurement gap configuration in at least the sense that the UE may continue performing UL and/or DL transmission an unaffected FR during a measurement gap corresponding to an affected FR.

However, cases have been identified where a UE using multiple RFICs may still make use of a per-UE measurement gap configuration (e.g., where UL/DL transmission is paused across all the RFICs during the measurement gap).

For example, consider a case where a UE has two separate RFICs, one each for FR1 and FR2. Further, assume the UE has been configured with 10 component carriers (CCs), all of which belong to FR2. Then, the UE is configured to measure a FR1 MO (denoted “f1”).

According to the per-FR measurement gap configuration as described above, this case corresponds to a behavior where the UE does not need to stop UL/DL transmission on FR2 in order to perform the measurement of f1 on FR1, due to FR1 having a separate RFIC. Accordingly, the UE might be expected to continue to perform UL/DL communication on the 10 active CC on FR2 while simultaneously measuring f1 on FR1 during a measurement gap.

However, it may be that a UE's baseband capability is limited to supporting only up to 10 simultaneous CCs. Due to this baseband capability limitation, the UE accordingly cannot both use the 10 active CC on FR2 while simultaneously measuring f1 on FR1, (because this would effectively be the simultaneous use of an 11th CC).

Thus, to allow for the measurement of f1, it may accordingly be advantageous to allow the UE to instead use a per-UE measurement gap configuration in this case, which would allow the UE to stop the active use of all CCs at the UE (e.g., stop the use of the active CCs on FR2) corresponding to the time of the measurement gap such that the UE has the capability of measuring f1.

More generally stated, it has been identified that there may be particular circumstances (e.g., corresponding to a saturation of one or more UE baseband capabilities) where a UE that is otherwise capable using a per-FR measurement gap configuration instead should use a per-UE measurement gap configuration.

A UE's baseband capability may be controlled by and/or correspond to, for example, a buffer size used at the UE and/or a processing capability at the UE, etc. A number of simultaneous CCs that a UE is able to use within such a baseband capability may be referred to herein as a “CC capability” of the UE. Accordingly, a CC capability of the UE may (also) be understood to be controlled by and/or correspond to the buffer size used at the UE, the processing capability at the UE, etc.

A number of CCs used at a UE may correspond to a band combination that is configured for the UE. Each band of the band combination includes one or more CCs, and thus it may be understood that a particular band combination may accordingly establish a total number of CCs that are configured for the UE.

It may be that, in some cases, a UE that is capable of using per-FR measurement gap procedures is further configured to provide the network with an indication of whether a particular band combination is not feasible with per-FR measurement gap operation. This may occur, for example, when a band combination that is configured to the UE includes a number of CCs that is greater than or equal to a CC capability of the UE. Such a UE may first indicate to the network that the UE is capable of performing per-PR measurement gap operations. Then, based on a number of CCs in a band combination that has been configured to the UE, the UE may determine whether or not per-FR measurement gap procedures are feasible with that band configuration. If the number of CCs in the band combination is greater than or equal to the number of CCs under a CC capability of the UE, the UE may send the network an indication that per-FR measurement gap procedures are not feasible with the current band combination.

The UE may accordingly determine to use per-UE measurement gap procedures, rather than per-RF measurement gap procedures, going forward (while that band combination is active). Further, as a result of the indication regarding the infeasibility of using the current band combination with per-RF measurement gap procedures, the network may perform scheduling for the UE under the assumption that the UE will use a per-UE measurement gap configuration rather than a per-RF measurement gap configuration.

In some embodiments, it may be that a UE is configured to provide, in addition to the indication that the present band configuration is not feasible with per-RF measurement gap procedures, a further infeasibility indication for each “fallback” band configuration corresponding to the present band configuration that is also infeasible for use with per-RF measurement gap procedures. For example, it may be that a current band combination configured to the UE has 12 CCs, and that the CC capability of the UE is up to only 10 CCs. In such circumstances (e.g., for the reasons described above) all fallback band configurations from the current band configuration that use 11 or 10 CCs would also be considered infeasible for use with per-FR measurement gap procedures at the UE.

For the case of 11 CC fallbacks: because there are 12 ways to select 11 CCs from the 12 CCs, the UE would need to make 12 indications to cover each possible 11 CC fallback case.

For the case of 10 CC fallbacks: because there are 66 ways to select 10 CCs from the 12 CCs, the UE would need to make 66 indications to cover each possible 10 CC fallback case.

Accordingly, the UE configured as has been supposed may ultimately make a total of 79 (1+12+66) infeasibility indications in order to cover the infeasibility indication for each of the current band combination and each of its related fallback band combinations that are also infeasible. As will be understood from this example, the described method of making infeasibility indications can result generally in significant signaling overhead in various possible circumstances.

Discussion herein may relate to systems and methods that improve the manner in which a UE uses infeasibility indications, and/or to systems and methods that may be used to (additionally or alternatively) inform the network of broader circumstances controlling the infeasibility of various band combinations at the UE. In such cases, it may be that the overall signaling overhead between the UE and the network may be reduced relative to other cases discussed herein.

It may be that, in some circumstances, a UE capable of per-FR measurement gap procedures that is at its CC capability may in any event be able to use per-FR measurement gap procedures (rather than using per-UE measurement gap procedures in such a case). For example, it may be that one or more CCs of the band combination correspond to FR1, while one or more CCs of the band combination correspond to FR2. The use of per-FR measurement gap procedures in such a case will not be problematic. This is because when the UE uses a measurement gap to pause the use of one of the FRIC (corresponding to one of FR1 or FR2) in order to measure the MO, at least the use of one CC will be paused (in whatever case). In such circumstances, the UE will not have to exceed its CC capability in order to perform the measurement of the MO.

Accordingly, it may be that a UE is configured to send infeasibility indications regarding a band combination only in cases where the CCs of the band combination are all in the same FR. This is because when all the CCs of the band combination are in the same FR, it is still possible for the number of CCs equal to the CC capability to all be active in a first FR, preventing the measurement of the MO in the second FR per the CC capability.

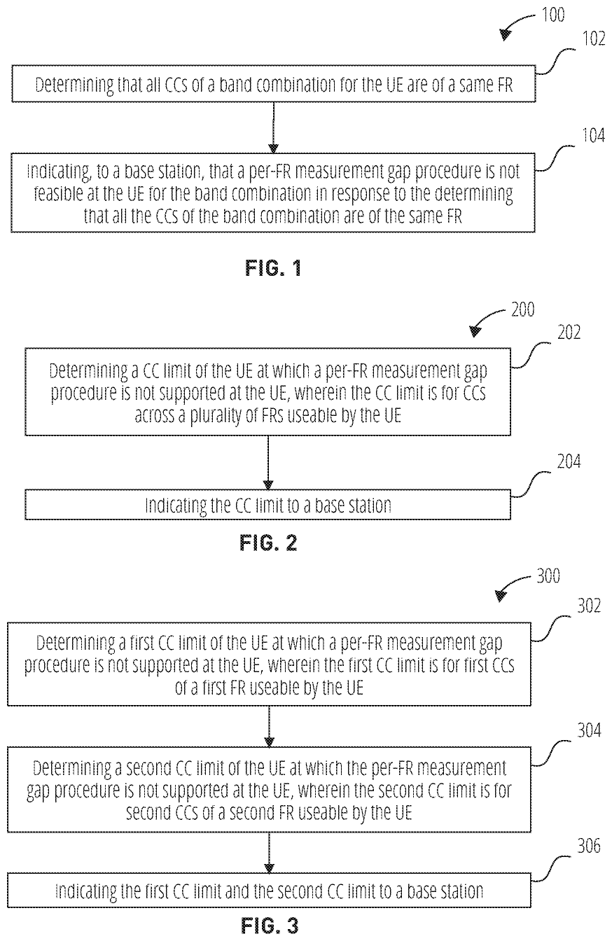

FIG. 1 illustrates a method 100 of a UE, according to an embodiment. The method 100 includes determining 102 that all CCs of a band combination for the UE are of a same FR.

The method 100 further includes indicating 104, to a base station, that a per-FR measurement gap procedure is not feasible at the UE for the band combination in response to the determining that all the CCs of the band combination are of the same FR.

Embodiments contemplated herein include an apparatus comprising means to perform one or more elements of the method 100. This apparatus may be, for example, an apparatus of a UE (such as a wireless device 902 that is a UE, as described herein).

Embodiments contemplated herein include one or more non-transitory computer-readable media comprising instructions to cause an electronic device, upon execution of the instructions by one or more processors of the electronic device, to perform one or more elements of the method 100. This non-transitory computer-readable media may be, for example, a memory of a UE (such as a memory 906 of a wireless device 902 that is a UE, as described herein).

Embodiments contemplated herein include an apparatus comprising logic, modules, or circuitry to perform one or more elements of the method 100. This apparatus may be, for example, an apparatus of a UE (such as a wireless device 902 that is a UE, as described herein).

Embodiments contemplated herein include an apparatus comprising: one or more processors and one or more computer-readable media comprising instructions that, when executed by the one or more processors, cause the one or more processors to perform one or more elements of the method 100. This apparatus may be, for example, an apparatus of a UE (such as a wireless device 902 that is a UE, as described herein).

Embodiments contemplated herein include a signal as described in or related to one or more elements of the method 100.

Embodiments contemplated herein include a computer program or computer program product comprising instructions, wherein execution of the program by a processor is to cause the processor to carry out one or more elements of the method 100. The processor may be a processor of a UE (such as a processor(s) 904 of a wireless device 902 that is a UE, as described herein). These instructions may be, for example, located in the processor and/or on a memory of the UE (such as a memory 906 of a wireless device 902 that is a UE, as described herein).

In some cases, it may be that the UE indicates one or more CC limits beyond which a per-FR gap is determined to be infeasible. This one or more CC limit(s) may be determined by the UE corresponding to and/or related to the CC capability of the UE. As is described herein, the indication of one or more CC limits may be performed in some cases instead of, and in other cases in addition to, an indication of an infeasible band combination.

In a first option, the UE may determine a CC limit across all FRs used by the UE (e.g., across FR1 and FR2) for which per-FR measurement gap procedures are not feasible at the UE (denoted “N”). The UE may then indicate N to the network. In such a case, when a band combination has a total number of CCs that is greater than or equal to N, the UE may use a per-UE measurement gap instead of a per-FR measurement gap, and/or the network may schedule UL/DL transmission with the UE assuming that the UE is using a per-UE measurement gap instead of a per-FR measurement gap. In some embodiments, the value of N may be or correspond to the CC capability of the UE, as is described herein.

In a second option, the UE may determine multiple CC limits, where each CC limit is for a particular FR. For example, the UE may indicate a first CC limit for FR1 for which per-FR measurement gap procedures are not feasible at the UE (denoted “N₁”) and a second CC limit for FR2 for which per-FR measurement gap procedures are not feasible at the UE (denoted “N₂”). The UE may then indicate the CC limits to the network. For example, the UE may indicate each of N₁ and N₂ to the network. In such a case, when the band combination has a number of CCs for any relevant FR for which the respective limit is reached (e.g., in the given example, either a number of FR1 CCs that is greater than or equal to N₁ and/or a number of FR2 CCs that is greater than or equal to N₂), the UE may use a per-UE measurement gap instead of a per-FR measurement gap, and/or the network may schedule UL/DL transmission with the UE assuming that the UE is using a per-UE measurement gap instead of a per-FR measurement gap.

It may be that a value for a CC limit (e.g., N, N₁, N₂, etc.) that is used by the UE is one of a predetermined set of numbers. For example, the UE may select a CC limit from the set [1 . . . 16] and/or the set [8, 10, 12, 14]. Note that these sets are given by way of example and not by way of limitation.

In some embodiments involving the indication of one or more CC limit(s), it may be that the UE can make further indications to the base station. For example, in some cases, the UE may also determine a maximum number of aggregated bands across all FRs for which the per-FR measurement gap procedure may be supported at the UE (denoted “M”). This maximum number of aggregated bands may then be indicated to the network. In the case that the number of aggregated bands in a band combination across all FRs is greater than M, the UE may use a per-UE measurement gap instead of a per-FR measurement gap, and/or the network may schedule UL/DL transmission with the UE assuming that the UE is using a per-UE measurement gap instead of a per-FR measurement gap.

The use of M may correspond to a processing capability of the UE, and may be useful to ensure that the UE is not tasked with performing a per-FR measurement gap procedure for a first FR when it does would have the processing resources to successfully do so while continuing UL/DL transmission in additional FR(s) (due to the total number of active bands).

In some cases, in addition to the indication of one or more CC limit(s), the UE may determine a maximum number of aggregated bands in a particular FR for which the per-FR measurement gap procedure may be supported at the UE (denoted “K”). This maximum number of aggregated bands in that FR may then also be indicated to the network. In the case that the number of aggregated bands in a band combination for that FR is greater than K, the UE may use a per-UE measurement gap instead of a per-FR measurement gap, and/or the network may schedule UL/DL transmission with the UE assuming that the UE is using a per-UE measurement gap instead of a per-FR measurement gap. In some embodiments, it is anticipated that K may be a maximum number of aggregated bands within FR2.

The use of K may correspond to a processing capability of the UE, and may be useful to ensure that the UE is not tasked with performing a per-FR measurement gap for a first FR procedure when it would not have the processing resources to successfully do so while continuing UL/DL transmission in the FR corresponding to K (e.g., FR2) (due to the total number of active bands in the FR corresponding to K). It is contemplated that in some embodiments, value K could be determined and indicated along with a value M as has been described herein.

In some cases, in addition to the indication of one or more CC limit(s), the UE may determine a maximum number of FRs at the UE for which a per-FR measurement gap procedure is supported at the UE (denoted “S”). This maximum number of FRs may then also be indicated to the network. In the case that the number of FRs in a band combination is greater than S, the UE may use a per-UE measurement gap instead of a per-RF measurement gap, and/or the network may schedule UL/DL transmission with the UE assuming that the UE is using a per-UE measurement gap instead of a per-RF measurement gap.

The use of S may be useful in the case where, for example, there is still some sharing in hardware between a plurality of RFICs at the UE (e.g., a shared RF chain among the RFICs), such that the RFICs are not totally separate and therefore there may be interference to UL/DL transmissions on a second FR when a first FR is paused for a measurement gap. It is contemplated that in some embodiments, a value S could be determined and indicated along with a value M as has been described herein.

It is further contemplated that in some embodiments, in addition to the indication of one or more CC limit(s) (e.g., N, N₁, N₂, etc.), a UE may determine and indicate each of M, K, and S, or determine and indicate each of any subset taken from M, K, and S, as these have been described herein.

FIG. 2 illustrates a method 200 of a UE, according to an embodiment. The method 200 includes determining 202 a CC limit of the UE at which a per-FR measurement gap procedure is not supported at the UE, wherein the CC limit is for CCs across a plurality of FRs useable by the UE.

The method 200 further includes indicating 204, the CC limit to a base station.

In some embodiments, the method 200 further includes determining a maximum number of aggregated bands for which the per-FR measurement gap procedure is supported at the UE and indicating the maximum number of aggregated bands to the base station. In some of these embodiments, the maximum number of aggregated bands is a maximum number of aggregated bands across all FRs. In some of these embodiments, the maximum number of aggregated bands is a maximum number of aggregated FR2 bands.

In some embodiments, the method 200 further includes determining a maximum number of FRs at the UE for which the per-FR measurement gap procedure is supported at the UE and indicating the maximum number of FRs to the base station.

In some embodiments of the method 200, the CC limit is one of a predetermined set of numbers.

Embodiments contemplated herein include an apparatus comprising means to perform one or more elements of the method 200. This apparatus may be, for example, an apparatus of a UE (such as a wireless device 902 that is a UE, as described herein).

Embodiments contemplated herein include one or more non-transitory computer-readable media comprising instructions to cause an electronic device, upon execution of the instructions by one or more processors of the electronic device, to perform one or more elements of the method 200. This non-transitory computer-readable media may be, for example, a memory of a UE (such as a memory 906 of a wireless device 902 that is a UE, as described herein).

Embodiments contemplated herein include an apparatus comprising logic, modules, or circuitry to perform one or more elements of the method 200. This apparatus may be, for example, an apparatus of a UE (such as a wireless device 902 that is a UE, as described herein).

Embodiments contemplated herein include an apparatus comprising: one or more processors and one or more computer-readable media comprising instructions that, when executed by the one or more processors, cause the one or more processors to perform one or more elements of the method 200. This apparatus may be, for example, an apparatus of a UE (such as a wireless device 902 that is a UE, as described herein).

Embodiments contemplated herein include a signal as described in or related to one or more elements of the method 200.

Embodiments contemplated herein include a computer program or computer program product comprising instructions, wherein execution of the program by a processor is to cause the processor to carry out one or more elements of the method 200. The processor may be a processor of a UE (such as a processor(s) 904 of a wireless device 902 that is a UE, as described herein). These instructions may be, for example, located in the processor and/or on a memory of the UE (such as a memory 906 of a wireless device 902 that is a UE, as described herein).

FIG. 3 illustrates a method 300 of a UE, according to an embodiment. The method 300 includes determining 302 a first CC limit of the UE at which a per-FR measurement gap procedure is not supported at the UE, wherein the first CC limit is for first CCs of a first FR useable by the UE.

The method 300 further includes determining 304 a second CC limit of the UE at which the per-FR measurement gap procedure is not supported at the UE, wherein the second CC limit is for second CCs of a second FR useable by the UE.

The method 300 further includes indicating 306 the first CC limit and the second CC limit to a base station.

In some embodiments, the method 300 further includes determining a maximum number of aggregated bands for which the per-FR measurement gap procedure is supported at the UE and indicating the maximum number of aggregated bands to the base station. In some of these embodiments, the maximum number of aggregated bands is a maximum number of aggregated bands across all FRs. In some of these embodiments, the maximum number of aggregated bands is a maximum number of aggregated FR2 bands.

In some embodiments, the method 300 further includes determining a maximum number of FRs at the UE for which the per-FR measurement gap procedure is supported at the UE and indicating the maximum number of FRs to the base station.

In some embodiments of the method 300, each of the first CC limit and the second CC limit are one of a predetermined set of numbers.

Embodiments contemplated herein include an apparatus comprising means to perform one or more elements of the method 300. This apparatus may be, for example, an apparatus of a UE (such as a wireless device 902 that is a UE, as described herein).

Embodiments contemplated herein include one or more non-transitory computer-readable media comprising instructions to cause an electronic device, upon execution of the instructions by one or more processors of the electronic device, to perform one or more elements of the method 300. This non-transitory computer-readable media may be, for example, a memory of a UE (such as a memory 906 of a wireless device 902 that is a UE, as described herein).

Embodiments contemplated herein include an apparatus comprising logic, modules, or circuitry to perform one or more elements of the method 300. This apparatus may be, for example, an apparatus of a UE (such as a wireless device 902 that is a UE, as described herein).

Embodiments contemplated herein include an apparatus comprising: one or more processors and one or more computer-readable media comprising instructions that, when executed by the one or more processors, cause the one or more processors to perform one or more elements of the method 300. This apparatus may be, for example, an apparatus of a UE (such as a wireless device 902 that is a UE, as described herein).

Embodiments contemplated herein include a signal as described in or related to one or more elements of the method 300.

Embodiments contemplated herein include a computer program or computer program product comprising instructions, wherein execution of the program by a processor is to cause the processor to carry out one or more elements of the method 300. The processor may be a processor of a UE (such as a processor(s) 904 of a wireless device 902 that is a UE, as described herein). These instructions may be, for example, located in the processor and/or on a memory of the UE (such as a memory 906 of a wireless device 902 that is a UE, as described herein).

In some cases, the UE may determine and/or indicate one or more CC limits (e.g., N, N₁, N₂, etc.) in the manner described herein in response to a determination that all CCs of a band combination configured at the UE are of the same FR. If not all of the CCs of the band combination are of the same FR, it may be that the UE does not then determine and/or indicate the one or more CC limits.

In cases where all the CCs of the band combination are of the same FR and the UE determines and/or indicates to the network one or more CC limits in response, the UE may also determine and indicate to the network a maximum number of aggregated bands across all FRs for which the per-FR measurement gap procedure may be supported at the UE M, a maximum number of aggregated bands in a particular FR for which the per-FR measurement gap procedure may be supported at the UE K, and/or a maximum number of FRs at the UE for which a per-FR measurement gap procedure is supported at the UE S, as these have been discussed herein. In these cases, particular combinations of indicating CC limits (e.g., N, N₁, N₂, etc.) with indications for one or more of M, K, and/or S may occur as has been described elsewhere herein.

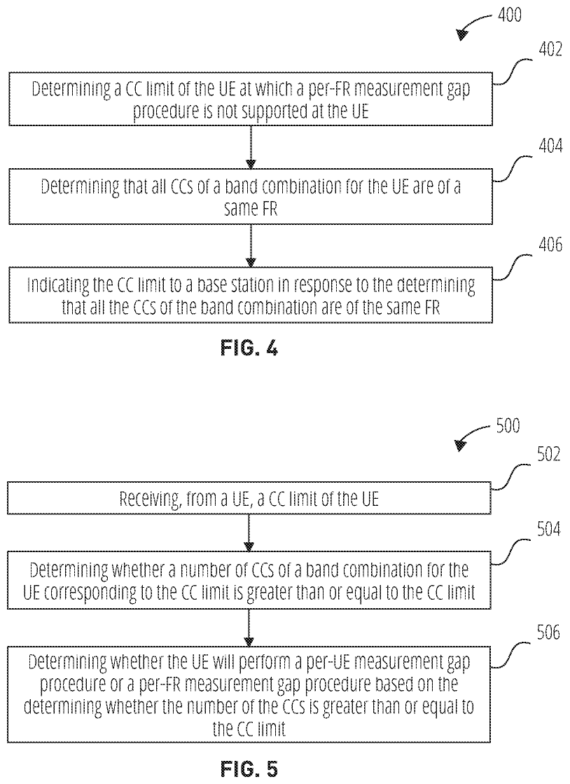

FIG. 4 illustrates a method 400 of a UE, according to an embodiment. The method 400 includes determining 402 a CC limit of the UE at which a per-FR measurement gap procedure is not supported at the UE.

The method 400 further includes determining 404 that all CCs of a band combination for the UE are of a same FR.

The method 400 further includes indicating 406 the CC limit to a base station in response to the determining that all the CCs of the band combination are of the same FR.

In some embodiments, the method 400 further includes determining a maximum number of aggregated bands for which the per-FR measurement gap procedure is supported at the UE and indicating the maximum number of aggregated bands to the base station. In some of these embodiments, the maximum number of aggregated bands is a maximum number of aggregated bands across all FRs. In some of these embodiments, the maximum number of aggregated bands is a maximum number of aggregated FR2 bands.

In some embodiments, the method 400 further includes determining a maximum number of FRs at the UE for which the per-FR measurement gap procedure is supported at the UE and indicating the maximum number of FRs to the base station.

In some embodiments of the method 400, the CC limit is one of a predetermined set of numbers.

In some embodiments of the method 400, the CC limit is for CCs across a plurality of FRs useable by the UE.

In some embodiments of the method 400, the CC limit is for CCs of one of a plurality of FRs useable by the UE.

Embodiments contemplated herein include an apparatus comprising means to perform one or more elements of the method 400. This apparatus may be, for example, an apparatus of a UE (such as a wireless device 902 that is a UE, as described herein).

Embodiments contemplated herein include one or more non-transitory computer-readable media comprising instructions to cause an electronic device, upon execution of the instructions by one or more processors of the electronic device, to perform one or more elements of the method 400. This non-transitory computer-readable media may be, for example, a memory of a UE (such as a memory 906 of a wireless device 902 that is a UE, as described herein).

Embodiments contemplated herein include an apparatus comprising logic, modules, or circuitry to perform one or more elements of the method 400. This apparatus may be, for example, an apparatus of a UE (such as a wireless device 902 that is a UE, as described herein).

Embodiments contemplated herein include an apparatus comprising: one or more processors and one or more computer-readable media comprising instructions that, when executed by the one or more processors, cause the one or more processors to perform one or more elements of the method 400. This apparatus may be, for example, an apparatus of a UE (such as a wireless device 902 that is a UE, as described herein).

Embodiments contemplated herein include a signal as described in or related to one or more elements of the method 400.

Embodiments contemplated herein include a computer program or computer program product comprising instructions, wherein execution of the program by a processor is to cause the processor to carry out one or more elements of the method 400. The processor may be a processor of a UE (such as a processor(s) 904 of a wireless device 902 that is a UE, as described herein). These instructions may be, for example, located in the processor and/or on a memory of the UE (such as a memory 906 of a wireless device 902 that is a UE, as described herein).

FIG. 5 illustrates a method 500 of a base station, according to an embodiment. The method 500 includes receiving 502, from a UE, a CC limit of the UE.

The method 500 further includes determining 504 whether a number of CCs of a band combination for the UE corresponding to the CC limit is greater than or equal to the CC limit.

The method 500 further includes determining 506 whether the UE will perform a per-UE measurement gap procedure or a per-FR measurement gap procedure based on the determining whether the number of the CCs is greater than or equal to the CC limit.

In some embodiments, the method 500 further includes receiving, from the UE, an indication of a maximum number of aggregated bands for the UE for which the per-FR measurement gap procedure is supported at the UE and determining whether the band combination uses more aggregated bands than the maximum number of aggregated bands, wherein the determining whether the UE will perform the per-UE measurement gap procedure or the per-FR measurement gap procedure is further based on the determining whether the band combination uses more aggregated bands than the maximum number of aggregated bands.

In some embodiments, the method 500 further includes receiving, from the UE, an indication of a maximum number of aggregated bands in FR2 for which the per-FR measurement gap procedure is supported at the UE and determining whether the band combination uses more aggregated bands in FR2 than the maximum number of aggregated bands in FR2, wherein the determining whether the UE will perform the per-UE measurement gap procedure or the per-FR measurement gap procedure is further based on the determining whether the band combination uses more aggregated bands in FR2 than the maximum number of aggregated bands in FR2.

In some embodiments, the method 500 further includes receiving, from the UE, an indication of a maximum number of FRs at the UE for which the per-FR measurement gap procedure is supported at the UE and determining whether the band combination uses more FRs than the maximum number of FRs, wherein the determining whether the UE will perform the per-UE measurement gap procedure or the per-FR measurement gap procedure is further based on the determining whether the band combination uses more FRs than the maximum number of FRs.

In some embodiments of the method 500, the CC limit is for CCs across a plurality of FRs useable by the UE.

In some embodiments of the method 500, the CC limit is for CCs of one of a plurality of FRs useable by the UE.

Embodiments contemplated herein include an apparatus comprising means to perform one or more elements of the method 500. This apparatus may be, for example, an apparatus of a base station (such as a network device 918 that is a base station, as described herein).

Embodiments contemplated herein include one or more non-transitory computer-readable media comprising instructions to cause an electronic device, upon execution of the instructions by one or more processors of the electronic device, to perform one or more elements of the method 500. This non-transitory computer-readable media may be, for example, a memory of a base station (such as a memory 922 of a network device 918 that is a base station, as described herein).

Embodiments contemplated herein include an apparatus comprising logic, modules, or circuitry to perform one or more elements of the method 500. This apparatus may be, for example, an apparatus of a base station (such as a network device 918 that is a base station, as described herein).

Embodiments contemplated herein include an apparatus comprising: one or more processors and one or more computer-readable media comprising instructions that, when executed by the one or more processors, cause the one or more processors to perform one or more elements of the method 500. This apparatus may be, for example, an apparatus of a base station (such as a network device 918 that is a base station, as described herein).

Embodiments contemplated herein include a signal as described in or related to one or more elements of the method 500.

Embodiments contemplated herein include a computer program or computer program product comprising instructions, wherein execution of the program by a processing element is to cause the processing element to carry out one or more elements of the method 500. The processor may be a processor of a base station (such as a processor(s) 920 of a network device 918 that is a base station, as described herein). These instructions may be, for example, located in the processor and/or on a memory of the base station (such as a memory 922 of a network device 918 that is a base station, as described herein).

In some embodiments, a UE may provide both an infeasibility indication for a particular band combination and an indication of one or more CC limits (e.g., N, N₁, N₂, etc.). The CC limit information may be used corresponding to any fallback band combinations for the band combination for which the infeasibility indication has been made. In such cases, it may be that the indication of the one or more CC limits is used by the network to analyze the feasibility of any fallback band combinations stemming from the beam combination for which the infeasibility indication is made, instead of the network relying on individual indications for each such fallback beam combination from the UE. It may accordingly be that the UE does not then make individual indications for each such fallback band combination.

In these cases, it may be that the initial infeasibility indication is not made except for in cases where the CCs of the band combination are all in the same FR, for the reasons that have been described herein.

Further, in these cases, when the infeasibility indication is made, the UE may also determine and indicate to the network a maximum number of aggregated bands across all FRs for which the per-FR measurement gap procedure may be supported at the UE M, a maximum number of aggregated bands in a particular FR for which the per-FR measurement gap procedure may be supported at the UE K, and/or a maximum number of FRs at the UE for which a per-FR measurement gap procedure is supported at the UE S, as these have been discussed herein. In these cases, particular combinations of indicating CC limits (e.g., N, N₁, N₂, etc.) for any fallback band combinations with indications for one or more of M, K, and/or S may occur as has described elsewhere herein.

These values N, N₁, N₂, M, K, and/or S (as the case may be) may be used by the network to analyze the fallback band combinations corresponding to the particular band combination for which the infeasibility indication was directly made. These values may be used as described herein to determine whether the UE will ultimately use per-FR or per-UE measurement gap procedures in various cases (e.g., when the UE is using that particular fallback beam combination).

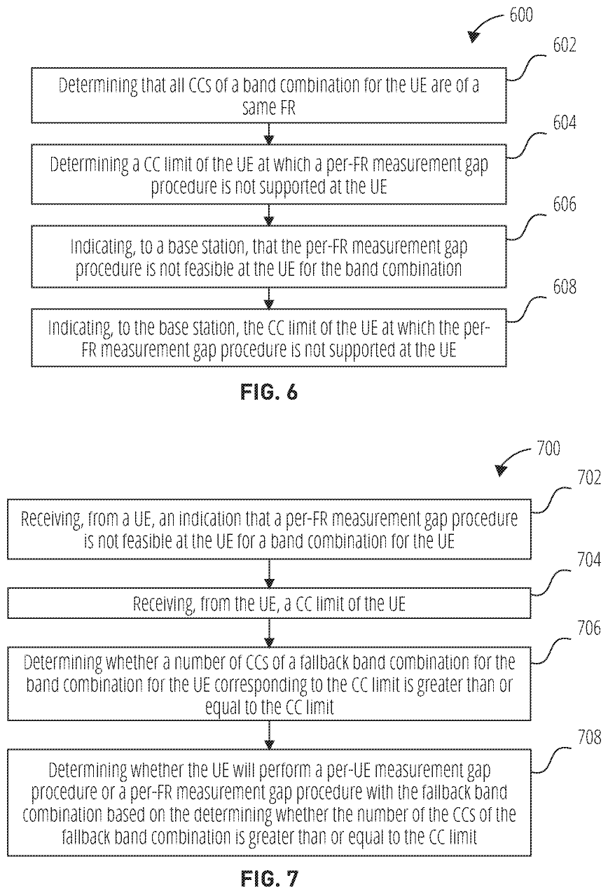

FIG. 6 illustrates a method 600 of a UE, according to an embodiment. The method 600 includes determining 602 that all CCs of a band combination for the UE are of a same FR.

The method 600 further includes determining 604 a CC limit of the UE at which a per-FR measurement gap procedure is not supported at the UE.

The method 600 further includes indicating 606, to a base station, that the per-FR measurement gap procedure is not feasible at the UE for the band combination.

The method 600 further includes indicating 608, to the base station, the CC limit of the UE at which the per-FR measurement gap procedure is not supported at the UE.

In some embodiments, the method 600 further includes determining a maximum number of aggregated bands for which the per-FR measurement gap procedure is supported at the UE and indicating the maximum number of aggregated bands to the base station. In some of these embodiments, the maximum number of aggregated bands is a maximum number of aggregated bands across all FRs. In some of these embodiments, the maximum number of aggregated bands is a maximum number of aggregated FR2 bands.

In some embodiments, the method 600 further includes determining a maximum number of FRs at the UE for which the per-FR measurement gap procedure is supported at the UE and indicating the maximum number of FRs to the base station.

In some embodiments of the method 600, the CC limit is for CCs across a plurality of FRs useable by the UE.

In some embodiments of the method 600, the CC limit is for CCs of one of a plurality of FRs useable by the UE.

Embodiments contemplated herein include an apparatus comprising means to perform one or more elements of the method 600. This apparatus may be, for example, an apparatus of a UE (such as a wireless device 902 that is a UE, as described herein).

Embodiments contemplated herein include one or more non-transitory computer-readable media comprising instructions to cause an electronic device, upon execution of the instructions by one or more processors of the electronic device, to perform one or more elements of the method 600. This non-transitory computer-readable media may be, for example, a memory of a UE (such as a memory 906 of a wireless device 902 that is a UE, as described herein).

Embodiments contemplated herein include an apparatus comprising logic, modules, or circuitry to perform one or more elements of the method 600. This apparatus may be, for example, an apparatus of a UE (such as a wireless device 902 that is a UE, as described herein).

Embodiments contemplated herein include an apparatus comprising: one or more processors and one or more computer-readable media comprising instructions that, when executed by the one or more processors, cause the one or more processors to perform one or more elements of the method 600. This apparatus may be, for example, an apparatus of a UE (such as a wireless device 902 that is a UE, as described herein).

Embodiments contemplated herein include a signal as described in or related to one or more elements of the method 600.

Embodiments contemplated herein include a computer program or computer program product comprising instructions, wherein execution of the program by a processor is to cause the processor to carry out one or more elements of the method 600. The processor may be a processor of a UE (such as a processor(s) 904 of a wireless device 902 that is a UE, as described herein). These instructions may be, for example, located in the processor and/or on a memory of the UE (such as a memory 906 of a wireless device 902 that is a UE, as described herein).

FIG. 7 illustrates a method 700 of a base station, according to an embodiment. The method 700 includes receiving 702, from a UE, an indication that a per-FR measurement gap procedure is not feasible at the UE for a band combination for the UE.

The method 700 further includes receiving 704, from the UE, a CC limit of the UE.

The method 700 further includes determining 706 whether a number of CCs of a fallback band combination for the band combination for the UE corresponding to the CC limit is greater than or equal to the CC limit.

The method 700 further includes determining 708 whether the UE will perform a per-UE measurement gap procedure or a per-FR measurement gap procedure with the fallback band combination based on the determining whether the number of the CCs of the fallback band combination is greater than or equal to the CC limit.

In some embodiments, the method 700 further includes receiving, from the UE, an indication of a maximum number of aggregated bands for the UE for which the per-FR measurement gap procedure is supported at the UE and determining whether the fallback band combination uses more aggregated bands than the maximum number of aggregated bands, wherein the determining whether the UE will perform the per-UE measurement gap procedure or the per-FR measurement gap procedure is further based on the determining whether the fallback band combination uses more aggregated bands than the maximum number of aggregated bands.

In some embodiments, the method 700 further includes receiving, from the UE, an indication of a maximum number of aggregated bands in FR2 for which the per-FR measurement gap procedure is supported at the UE and determining whether the fallback band combination uses more aggregated bands in FR2 than the maximum number of aggregated bands in FR2, wherein the determining whether the UE will perform the per-UE measurement gap procedure or the per-FR measurement gap procedure is further based on the determining whether the fallback band combination uses more aggregated bands in FR2 than the maximum number of aggregated bands in FR2.

In some embodiments, the method 700 further includes receiving, from the UE, an indication of a maximum number of FRs at the UE for which the per-FR measurement gap procedure is supported at the UE and determining whether the fallback band combination uses more FRs than the maximum number of FRs, wherein the determining whether the UE will perform the per-UE measurement gap procedure or the per-FR measurement gap procedure is further based on the determining whether the fallback band combination uses more FRs than the maximum number of FRs.

In some embodiments of the method 700, the CC limit is for CCs across a plurality of FRs useable by the UE.

In some embodiments of the method 700, the CC limit is for CCs of one of a plurality of FRs useable by the UE.

Embodiments contemplated herein include an apparatus comprising means to perform one or more elements of the method 700. This apparatus may be, for example, an apparatus of a base station (such as a network device 918 that is a base station, as described herein).

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of a base station (such as a memory 922 of a network device 918 that is a base station, as described herein).

Embodiments contemplated herein include an apparatus comprising logic, modules, or circuitry to perform one or more elements of the method 700. This apparatus may be, for example, an apparatus of a base station (such as a network device 918 that is a base station, as described herein).

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of a base station (such as a network device 918 that is a base station, as described herein).

Embodiments contemplated herein include a signal as described in or related to one or more elements of the method 700.

Embodiments contemplated herein include a computer program or computer program product comprising instructions, wherein execution of the program by a processing element is to cause the processing element to carry out one or more elements of the method 700. The processor may be a processor of a base station (such as a processor(s) 920 of a network device 918 that is a base station, as described herein). These instructions may be, for example, located in the processor and/or on a memory of the base station (such as a memory 922 of a network device 918 that is a base station, as described herein).

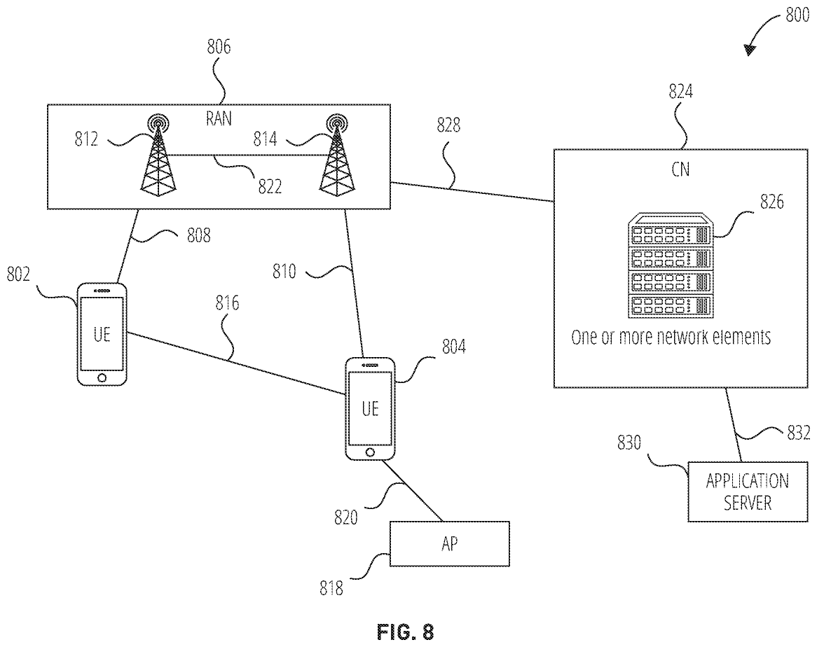

FIG. 8 illustrates an example architecture of a wireless communication system 800, according to embodiments disclosed herein. The following description is provided for an example wireless communication system 800 that operates in conjunction with the LTE system standards and/or 5G or NR system standards as provided by 3GPP technical specifications.

As shown by FIG. 8, the wireless communication system 800 includes UE 802 and UE 804 (although any number of UEs may be used). In this example, the UE 802 and the UE 804 are illustrated as smartphones (e.g., handheld touchscreen mobile computing devices connectable to one or more cellular networks), but may also comprise any mobile or non-mobile computing device configured for wireless communication.

The UE 802 and UE 804 may be configured to communicatively couple with a RAN 806. In embodiments, the RAN 806 may be NG-RAN, E-UTRAN, etc. The UE 802 and UE 804 utilize connections (or channels) (shown as connection 808 and connection 810, respectively) with the RAN 806, each of which comprises a physical communications interface. The RAN 806 can include one or more base stations, such as base station 812 and base station 814, that enable the connection 808 and connection 810.

In this example, the connection 808 and connection 810 are air interfaces to enable such communicative coupling, and may be consistent with RAT(s) used by the RAN 806, such as, for example, an LTE and/or NR.

In some embodiments, the UE 802 and UE 804 may also directly exchange communication data via a sidelink interface 816. The UE 804 is shown to be configured to access an access point (shown as AP 818) via connection 820. By way of example, the connection 820 can comprise a local wireless connection, such as a connection consistent with any IEEE 802.11 protocol, wherein the AP 818 may comprise a Wi-Fi® router. In this example, the AP 818 may be connected to another network (for example, the Internet) without going through a CN 824.

In embodiments, the UE 802 and UE 804 can be configured to communicate using orthogonal frequency division multiplexing (OFDM) communication signals with each other or with the base station 812 and/or the base station 814 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 812 or base station 814 may be implemented as one or more software entities running on server computers as part of a virtual network. In addition, or in other embodiments, the base station 812 or base station 814 may be configured to communicate with one another via interface 822. In embodiments where the wireless communication system 800 is an LTE system (e.g., when the CN 824 is an EPC), the interface 822 may be an X2 interface. The X2 interface may be defined between two or more base stations (e.g., two or more eNBs and the like) that connect to an EPC, and/or between two eNBs connecting to the EPC. In embodiments where the wireless communication system 800 is an NR system (e.g., when CN 824 is a 5GC), the interface 822 may be an Xn interface. The Xn interface is defined between two or more base stations (e.g., two or more gNBs and the like) that connect to 5GC, between a base station 812 (e.g., a gNB) connecting to 5GC and an eNB, and/or between two eNBs connecting to 5GC (e.g., CN 824).

The RAN 806 is shown to be communicatively coupled to the CN 824. The CN 824 may comprise one or more network elements 826, which are configured to offer various data and telecommunications services to customers/subscribers (e.g., users of UE 802 and UE 804) who are connected to the CN 824 via the RAN 806. The components of the CN 824 may be implemented in one physical device or separate physical devices including components to read and execute instructions from a machine-readable or computer-readable medium (e.g., a non-transitory machine-readable storage medium).

In embodiments, the CN 824 may be an EPC, and the RAN 806 may be connected with the CN 824 via an S1 interface 828. In embodiments, the SI interface 828 may be split into two parts, an S1 user plane (S1-U) interface, which carries traffic data between the base station 812 or base station 814 and a serving gateway (S-GW), and the S1-MME interface, which is a signaling interface between the base station 812 or base station 814 and mobility management entities (MMEs).

In embodiments, the CN 824 may be a 5GC, and the RAN 806 may be connected with the CN 824 via an NG interface 828. In embodiments, the NG interface 828 may be split into two parts, an NG user plane (NG-U) interface, which carries traffic data between the base station 812 or base station 814 and a user plane function (UPF), and the S1 control plane (NG-C) interface, which is a signaling interface between the base station 812 or base station 814 and access and mobility management functions (AMFs).

Generally, an application server 830 may be an element offering applications that use internet protocol (IP) bearer resources with the CN 824 (e.g., packet switched data services). The application server 830 can also be configured to support one or more communication services (e.g., VoIP sessions, group communication sessions, etc.) for the UE 802 and UE 804 via the CN 824. The application server 830 may communicate with the CN 824 through an IP communications interface 832.

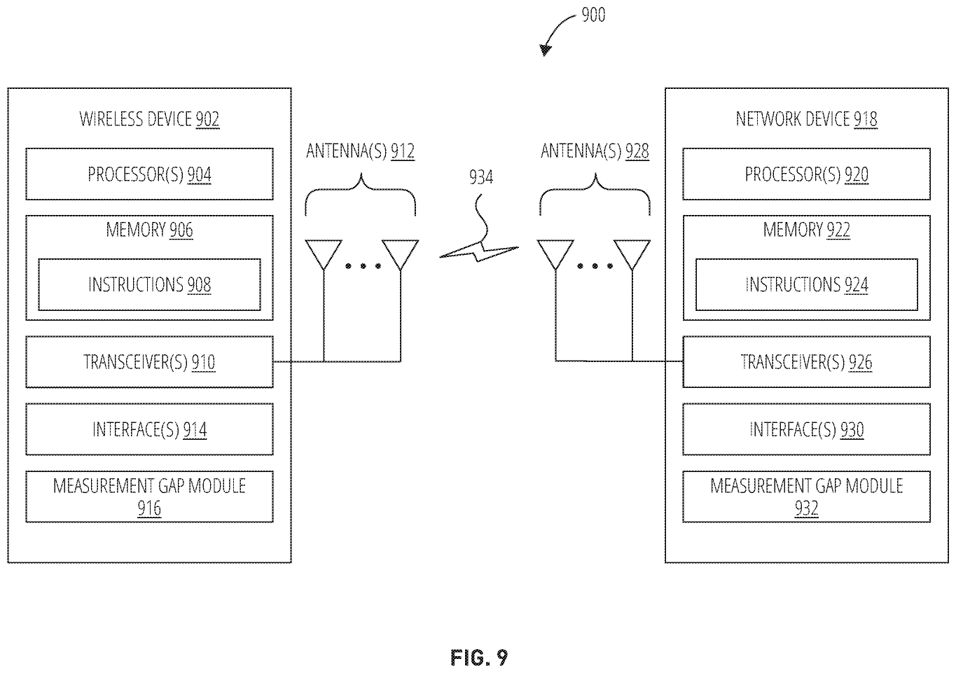

FIG. 9 illustrates a system 900 for performing signaling 934 between a wireless device 902 and a network device 918, according to embodiments disclosed herein. The system 900 may be a portion of a wireless communications system as herein described. The wireless device 902 may be, for example, a UE of a wireless communication system. The network device 918 may be, for example, a base station (e.g., an eNB or a gNB) of a wireless communication system.

The wireless device 902 may include one or more processor(s) 904. The processor(s) 904 may execute instructions such that various operations of the wireless device 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The wireless device 902 may include one or more transceiver(s) 910 that may include radio frequency (RF) transmitter and/or receiver circuitry that use the antenna(s) 912 of the wireless device 902 to facilitate signaling (e.g., the signaling 934) to and/or from the wireless device 902 with other devices (e.g., the network device 918) according to corresponding RATs.

The wireless device 902 may include one or more antenna(s) 912 (e.g., one, two, four, or more). For embodiments with multiple antenna(s) 912, the wireless device 902 may leverage the spatial diversity of such multiple antenna(s) 912 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 902 may be accomplished according to precoding (or digital beamforming) that is applied at the wireless device 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 902 may implement analog beamforming techniques, whereby phases of the signals sent by the antenna(s) 912 are relatively adjusted such that the (joint) transmission of the antenna(s) 912 can be directed (this is sometimes referred to as beam steering).

The wireless device 902 may include one or more interface(s) 914. The interface(s) 914 may be used to provide input to or output from the wireless device 902. For example, a wireless device 902 that is a UE may include interface(s) 914 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 910/antenna(s) 912 already described) that allow for communication between the UE and other devices and may operate according to known protocols (e.g., Wi-Fi®, Bluetooth®, and the like).

The wireless device 902 may include a measurement gap module 916. The measurement gap module 916 may be implemented via hardware, software, or combinations thereof. For example, the measurement gap module 916 may be implemented as a processor, circuit, and/or instructions 908 stored in the memory 906 and executed by the processor(s) 904. In some examples, the measurement gap module 916 may be integrated within the processor(s) 904 and/or the transceiver(s) 910. For example, the measurement gap module 916 may be implemented by a combination of software components (e.g., executed by a DSP or a general processor) and hardware components (e.g., logic gates and circuitry) within the processor(s) 904 or the transceiver(s) 910.

The measurement gap module 916 may be used for various aspects of the present disclosure, for example, aspects of FIG. 1 through FIG. 7. The measurement gap module 916 is configured to generate infeasibility indications to be sent to the network device 918, determine one or more CC limits to be sent to the network device 918, determine a maximum number of aggregated bands across all FRs for which the per-FR measurement gap procedure may be supported at the UE to be sent to the network device 918, determine a maximum number of aggregated bands in a particular FR for which the per-FR measurement gap procedure may be supported at the UE to be sent to the network device 918, and/or determine a maximum number of FRs at the UE for which a per-FR measurement gap procedure is supported at the UE to be sent to the network device 918, as is described herein.

The network device 918 may include one or more processor(s) 920. The processor(s) 920 may execute instructions such that various operations of the network device 918 are performed, as described herein. The processor(s) 920 may include one or more baseband processors implemented using, for example, a CPU, a DSP, an ASIC, a controller, an FPGA device, another hardware device, a firmware device, or any combination thereof configured to perform the operations described herein.

The network device 918 may include a memory 922. The memory 922 may be a non-transitory computer-readable storage medium that stores instructions 924 (which may include, for example, the instructions being executed by the processor(s) 920). The instructions 924 may also be referred to as program code or a computer program. The memory 922 may also store data used by, and results computed by, the processor(s) 920.

The network device 918 may include one or more transceiver(s) 926 that may include RF transmitter and/or receiver circuitry that use the antenna(s) 928 of the network device 918 to facilitate signaling (e.g., the signaling 934) to and/or from the network device 918 with other devices (e.g., the wireless device 902) according to corresponding RATs.

The network device 918 may include one or more antenna(s) 928 (e.g., one, two, four, or more). In embodiments having multiple antenna(s) 928, the network device 918 may perform MIMO, digital beamforming, analog beamforming, beam steering, etc., as has been described.

The network device 918 may include one or more interface(s) 930. The interface(s) 930 may be used to provide input to or output from the network device 918. For example, a network device 918 that is a base station may include interface(s) 930 made up of transmitters, receivers, and other circuitry (e.g., other than the transceiver(s) 926/antenna(s) 928 already described) that enables the base station to communicate with other equipment in a core network, and/or that enables the base station to communicate with external networks, computers, databases, and the like for purposes of operations, administration, and maintenance of the base station or other equipment operably connected thereto.

The network device 918 may include a measurement gap module 932. The measurement gap module 932 may be implemented via hardware, software, or combinations thereof. For example, the measurement gap module 932 may be implemented as a processor, circuit, and/or instructions 924 stored in the memory 922 and executed by the processor(s) 920. In some examples, the measurement gap module 932 may be integrated within the processor(s) 920 and/or the transceiver(s) 926. For example, the measurement gap module 932 may be implemented by a combination of software components (e.g., executed by a DSP or a general processor) and hardware components (e.g., logic gates and circuitry) within the processor(s) 920 or the transceiver(s) 926.

The measurement gap module 932 may be used for various aspects of the present disclosure, for example, aspects of FIG. 1 through FIG. 7. The measurement gap module 932 is configured to utilize infeasibility indications received from the wireless device 902, utilize one or more CC limits received from the wireless device 902, utilize a maximum number of aggregated bands across all FRs for which the per-FR measurement gap procedure may be supported at the UE received from the wireless device 902, utilize a maximum number of aggregated bands in a particular FR for which the per-FR measurement gap procedure may be supported at the UE received from the wireless device 902, and/or utilize a maximum number of FRs at the UE for which a per-FR measurement gap procedure is supported at the UE received from the wireless device 902, as is described herein.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. (canceled)

2. A method of a user equipment (UE), comprising:
determining a component carrier (CC) limit of the UE at which a per-frequency range (FR) measurement gap procedure is not supported at the UE, wherein the CC limit is for CCs across a plurality of FRs useable by the UE; and
indicating the CC limit to a base station.

3. The method of claim 2, further comprising:
determining a maximum number of aggregated bands for which the per-FR measurement gap procedure is supported at the UE; and
indicating the maximum number of aggregated bands to the base station.

4. The method of claim 3, wherein the maximum number of aggregated bands is a maximum number of aggregated bands across all FRs.

5. The method of claim 3, wherein the maximum number of aggregated bands is a maximum number of aggregated frequency range 2 (FR2) bands.

6. The method of claim 2, further comprising:
determining a maximum number of FRs at the UE for which the per-FR measurement gap procedure is supported at the UE; and
indicating the maximum number of FRs to the base station.

7. The method of claim 2, wherein the CC limit is one of a predetermined set of numbers.

8. A method of a user equipment (UE), comprising:
determining a first component carrier (CC) limit of the UE at which a per-frequency range (FR) measurement gap procedure is not supported at the UE, wherein the first CC limit is for first CCs of a first FR useable by the UE:
determining a second CC limit of the UE at which the per-FR measurement gap procedure is not supported at the UE, wherein the second CC limit is for second CCs of a second FR useable by the UE; and
indicating the first CC limit and the second CC limit to a base station.

9. The method of claim 8, further comprising:
determining a maximum number of aggregated bands for which the per-FR measurement gap procedure is supported at the UE; and
indicating the maximum number of aggregated bands to the base station.

10. The method of claim 9, wherein the maximum number of aggregated bands is a maximum number of aggregated bands across all FRs.

11. The method of claim 9, wherein the maximum number of aggregated bands is a maximum number of aggregated frequency range 2 (FR2) bands.

12. The method of claim 8, further comprising:
determining a maximum number of FRs at the UE for which the per-FR measurement gap procedure is supported at the UE; and
indicating the maximum number of FRs to the base station.

13. The method of claim 8, wherein each of the first CC limit and the second CC limit are one of a predetermined set of numbers.

14-21. (canceled)

22. A method of a base station, comprising:
receiving, from a UE, a component carrier (CC) limit of the UE;
determining whether a number of CCs of a band combination for the UE corresponding to the CC limit is greater than or equal to the CC limit; and
determining whether the UE will perform a per-UE measurement gap procedure or a per-FR measurement gap procedure based on the determining whether the number of the CCs is greater than or equal to the CC limit.

23. The method of claim 22, further comprising:
receiving, from the UE, an indication of a maximum number of aggregated bands for the UE for which the per-FR measurement gap procedure is supported at the UE; and
determining whether the band combination uses more aggregated bands than the maximum number of aggregated bands:
wherein the determining whether the UE will perform the per-UE measurement gap procedure or the per-FR measurement gap procedure is further based on the determining whether the band combination uses more aggregated bands than the maximum number of aggregated bands.

24. The method of claim 22, further comprising:
receiving, from the UE, an indication of a maximum number of aggregated bands in frequency range 2 (FR2) for which the per-FR measurement gap procedure is supported at the UE; and
determining whether the band combination uses more aggregated bands in FR2 than the maximum number of aggregated bands in FR2:
wherein the determining whether the UE will perform the per-UE measurement gap procedure or the per-FR measurement gap procedure is further based on the determining whether the band combination uses more aggregated bands in FR2 than the maximum number of aggregated bands in FR2.

25. The method of claim 22, further comprising:
receiving, from the UE, an indication of a maximum number of FRs at the UE for which the per-FR measurement gap procedure is supported at the UE: and
determining whether the band combination uses more FRs than the maximum number of FRs:
wherein the determining whether the UE will perform the per-UE measurement gap procedure or the per-FR measurement gap procedure is further based on the determining whether the band combination uses more FRs than the maximum number of FRs.

26. The method of claim 22, wherein the CC limit is for CCs across a plurality of FRs useable by the UE.

27. The method of claim 22, wherein the CC limit is for CCs of one of a plurality of FRs useable by the UE.

28-42. (canceled)
